(19) United States
(12) Patent Application Publication
(10) Pub. No.: US 2026/0062081 A1
(43) Pub. Date: Mar. 5, 2026

(54) positioning device

(71) Applicant: Tianyu FU, Heze (CN)

(72) Inventor: Tianyu FU, Heze (CN)

(21) Appl. No.: 19/071,706

(22) Filed: Mar. 5, 2025

(30) Foreign Application Priority Data
Aug. 27, 2024 (CN) 202411180719.8
Aug. 27, 2024 (CN) 202422080008.5

(51) Int. Cl. B62J 3/10; F16M 13/02

(52) U.S. Cl. CPC B62J 3/10; F16M 13/022

(57) ABSTRACT

A non-limiting embodiment of the present disclosure relates to a positioning device comprising: a head portion including a first cap body and a second cap body, the first cap body and the second cap body enclosing a mounting cavity; a shank portion fixedly connected to the head portion, the shank portion including a mounting portion configured to secure the positioning device to a carrier; a positioning apparatus mounted within the mounting cavity and configured to communicatively connect with an electronic device to enable the electronic device to locate the carrier. This positioning device is particularly suitable for discreet installation via the shank portion (e.g., through threaded connection) on vehicles such as bicycles. Notably, this embodiment of the positioning device, featuring a head portion and a shank portion, can be used on any equipment (referred to as an external carrier) beyond transportation vehicles, provided there is a need for positioning.

### RELATED APPLICATIONS

The present patent document claims the benefit of priority to Patent Application No. 202422080008.5, filed Aug. 27, 2024, and entitled “positioning device,” and the benefit of priority to Patent Application No. 202411180719.8, filed Aug. 27, 2024, and entitled “positioning device,” the entire contents of each of which are incorporated herein by reference.

### BACKGROUND

### 1. Technical Field

The present disclosure relate to the field of positioning technology, and more particularly, to a positioning device and system.

### 2. Background Information

With the rapid advancement of urbanization and the widespread use of transportation means, vehicles such as bicycles and electric bicycles have become essential choices for daily commuting. However, due to their small size and portability, these vehicles are prone to being lost or stolen, resulting in economic losses and inconvenience to users. Additionally, locating parked vehicles in public parking areas or complex road conditions has become a significant challenge for users. Existing technologies lack efficient, practical, and discreet positioning devices capable of real-time tracking of vehicle locations and providing convenient retrieval services. Therefore, there is an urgent need to develop a device with integrated positioning functionality that can be mounted on bicycles and similar vehicles to enhance user safety and experience.

### BRIEF SUMMARY

To address the technical problems identified in the background, it is necessary to provide an improved positioning solution for transportation vehicles (referred to as an external carrier) such as bicycles, electric bicycles, scooters, and self-balancing vehicles, aiming to reduce the cost of the positioning solution, lower maintenance costs, and/or improve ease of use, such as enabling long-term autonomous power sustainability. To this end, a non-limiting embodiment of the present disclosure provides a positioning device comprising: a body including a fixed base attachable to a vehicle; a striking component mounted on the body and configured to perform a striking action in response to a user's hand operation; a sound component mounted on the body and configured to generate a bell sound in response to the striking action; a solar panel at least partially exposed on an exterior of the body; a processor coupled to the solar panel; and a communication circuit coupled to the processor and including an antenna configured to transmit wireless signals to an electronic device to enable the electronic device to locate the vehicle.

The positioning device can be applied to transportation vehicles such as bicycles, electric bicycles, scooters, and self-balancing vehicles, allowing indirect localization of the vehicle by tracking the positioning device. The position information of the positioning device can be indirectly uploaded to a server of a positioning system via a first electronic device (e.g., a mobile phone). Users can then use a second electronic device (e.g., their own mobile phone) to retrieve the location of the positioning device or the vehicle from the server, thereby locating the device and/or the vehicle equipped with it. Here, the first electronic device primarily refers to devices of individuals other than the user, particularly those in proximity to the positioning device, such as mobile phones. A key advantage of this positioning system is its ability to leverage the electronic devices of others (not just the user's own device) to indirectly locate the positioning device and/or vehicle, eliminating the need for costly active positioning systems like GPS or Beidou on the vehicle or device itself, thus significantly reducing the cost of the positioning solution.

Another non-limiting embodiment of the present disclosure provides a positioning device comprising: a housing including a top portion and a peripheral side portion, the top portion and the peripheral side portion together defining at least one receiving cavity; a fixed base mechanically coupled to the housing for securing the positioning device to a vehicle; a striking component pivotally mounted on the fixed base; a first sound component elastically mounted on an outer surface of the peripheral side portion of the housing; a solar panel fixedly mounted on an outer surface of the top portion of the housing; a controller, an energy storage component, a communication component, and a second sound component mounted within the at least one receiving cavity; wherein the striking component is configured to perform a striking action in response to a user's hand operation; the first sound component is configured to generate a first sound in response to the striking action; the energy storage component is coupled to the solar panel and stores electrical energy converted by the solar panel; the communication component is configured to periodically transmit a first wireless signal receivable by a first electronic device, the first electronic device locating the vehicle based on the first wireless signal; and the communication component is further configured to receive a second wireless signal transmitted by a second electronic device, the controller controlling the second sound component to generate a second sound based on the second wireless signal to assist the user in locating the positioning device.

Another non-limiting embodiment of the present disclosure provides a positioning device comprising: a head portion including a first cap body and a second cap body, the first cap body and the second cap body enclosing a mounting cavity; a shank portion fixedly connected to the head portion, the shank portion including a mounting portion configured to secure the positioning device to a carrier; a positioning apparatus mounted within the mounting cavity and configured to communicatively connect with an electronic device to enable the electronic device to locate the carrier. This positioning device is particularly suitable for discreet installation via the shank portion (e.g., through threaded connection) on vehicles such as bicycles. Notably, this embodiment of the positioning device, featuring a head portion and a shank portion, can be used on any equipment (also referred to as an external carrier) beyond transportation vehicles, provided there is a need for positioning.

### BRIEF DESCRIPTION OF THE DRAWINGS

To provide a clearer explanation of the technical solutions of the non-limiting embodiments of the present disclosure, the drawings required for describing the embodiments are briefly introduced below. It is evident that the drawings described below represent only some embodiments of the present disclosure. For those of ordinary skill in the art, additional drawings may be derived from these drawings without inventive effort.

FIG. 1 is a schematic diagram of a bell positioning system according to an embodiment of the present disclosure.

FIG. 2 is a schematic diagram of the system components of the bell shown in FIG. 1.

FIG. 3 illustrates steps involved in a method for positioning a bell according to an embodiment of the present disclosure.

FIG. 4 illustrates additional steps involved in a method for positioning a bell according to an embodiment of the present disclosure.

FIG. 5 is a perspective view of a bell according to an embodiment of the present disclosure.

FIG. 6 is a structural schematic diagram of a bell according to an embodiment of the present disclosure.

FIG. 7 is an exploded view of a bell according to an embodiment of the present disclosure.

FIG. 8 is another exploded view of a bell according to an embodiment of the present disclosure.

FIG. 9 is a cross-sectional view of a bell taken along line I-I of FIG. 5 according to an embodiment of the present disclosure.

FIG. 10 is a structural schematic diagram of a housing of a bell according to an embodiment of the present disclosure.

FIG. 11 is a cross-sectional view of a housing of a bell taken along line V-V of FIG. 9 according to an embodiment of the present disclosure.

FIG. 12 is a schematic diagram of the internal structure of a housing of a bell according to an embodiment of the present disclosure.

FIG. 13 is another perspective view of a bell according to an embodiment of the present disclosure.

FIG. 14 is an exploded view of a striking component of a bell according to an embodiment of the present disclosure.

FIG. 15 is an exploded view of the internal structure of a housing of a bell according to an embodiment of the present disclosure.

FIG. 16 is a structural schematic diagram of the top portion of a housing of a bell according to an embodiment of the present disclosure.

FIG. 17 is a structural schematic diagram of the peripheral side portion of a housing of a bell according to an embodiment of the present disclosure.

FIG. 18 is a schematic diagram illustrating the radius of a first outer surface and a second outer surface of a bell according to an embodiment of the present disclosure.

FIG. 19 is a diagram of electrical connection relationships within a bell according to an embodiment of the present disclosure.

FIG. 20 is a structural schematic diagram of a bell according to another embodiment of the present disclosure.

FIG. 21 is a cross-sectional view of a bell according to another embodiment of the present disclosure.

FIG. 22 is an exploded view of a bell according to another embodiment of the present disclosure.

FIG. 23 is a structural schematic diagram of a body of a bell according to another embodiment of the present disclosure.

FIG. 24 is a cross-sectional view of a bell along another direction according to another embodiment of the present disclosure.

FIG. 25 is a structural schematic diagram of a cover of a bell according to another embodiment of the present disclosure.

FIG. 26 is a structural schematic diagram of a sound component of a bell according to another embodiment of the present disclosure.

FIG. 27 is an exploded view of a striking component of a bell according to another embodiment of the present disclosure.

FIG. 28 is a diagram of electrical connection relationships within a positioning apparatus of a bell according to another embodiment of the present disclosure.

FIG. 29 is a structural schematic diagram of a positioning device according to yet another embodiment of the present disclosure.

FIG. 30 is an exploded view of a positioning device according to yet another embodiment of the present disclosure.

FIG. 31 is a cross-sectional view of a positioning device according to yet another embodiment of the present disclosure.

FIG. 32 is a structural schematic diagram of a first cap body of a positioning device according to yet another embodiment of the present disclosure.

FIG. 33 is a structural schematic diagram of a positioning apparatus of a positioning device according to yet another embodiment of the present disclosure.

FIG. 34 is a structural schematic diagram of a circuit board of a positioning device according to yet another embodiment of the present disclosure.

### DETAILED DESCRIPTION OF THE DRAWINGS AND THE PRESENTLY PREFERRED EMBODIMENTS

To make the objectives, features, and advantages of the present disclosure more apparent and understandable, specific embodiments/examples of the present disclosure are described in detail below with reference to the accompanying drawings. Numerous specific details are set forth in the following description to provide a thorough understanding of the disclosure. However, the disclosure can be implemented in many alternative ways different from those described herein. Those skilled in the art can make similar improvements to achieve identical or similar functional effects without departing from the spirit of the disclosure. Therefore, the disclosure, and particularly the claims related thereto, are not limited by the non-limiting embodiments disclosed below.

In the description of the present disclosure, it should be understood that terms such as “center,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” “circumferential,” or “inclined” indicate orientations or positional relationships based on those shown in the drawings. These terms are used solely for convenience in describing the disclosure and simplifying the description, and do not indicate or imply that the referenced device or element must have a specific orientation, be constructed, or operate in a specific orientation, and thus should not be construed as limiting the disclosure.

Furthermore, terms such as “first” and “second” or similar expressions are used for descriptive purposes only and should not be interpreted as indicating or implying relative importance or the number of technical features indicated. Thus, a feature defined with “first” or “second” may explicitly or implicitly include at least one such feature. In the description of the present disclosure, the term “plurality” means at least two, such as two or three, unless explicitly specified otherwise.

Unless explicitly specified and limited otherwise, terms indicating actions such as “coupled,” “mounted,” “connected,” “fixed,” “fitted,” “provided,” and “positioned” as used in the present disclosure should be interpreted broadly in light of the inventive concepts disclosed herein. For example, these terms may encompass at least direct implementation, indirect implementation, fixed implementation, or movable implementation. Taking “connected” as an example, it may refer to direct connection, indirect connection through a third-party component, fixed connection, or movable connection, such as via hinges. Similarly, “fixed” may refer to either non-detachably fixed or detachably fixed implementations.

Additionally, the term “coupled” as used herein may refer to two or more elements in direct physical, electrical, or communicative contact/connection, or indirect physical, electrical, or communicative contact/connection, and may also refer to two or more elements interacting or operating with each other.

Unless explicitly specified and limited otherwise, descriptions such as “a first feature on or under a second feature” may mean that the first feature and the second feature are in direct contact, or that the first and second features are in indirect contact via an intermediate medium. Furthermore, “a first feature above, over, or on top of a second feature” may mean that the first feature is directly above or obliquely above the second feature, or simply that the first feature is at a higher horizontal level than the second feature. Similarly, “a first feature below, under, or beneath a second feature” may mean that the first feature is directly below or obliquely below the second feature, or simply that the first feature is at a lower horizontal level than the second feature. Additionally, terms such as “vertical,” “horizontal,” “upper,” “lower,” “left,” “right,” and similar expressions used in the present disclosure are for descriptive purposes only and do not indicate a unique implementation.

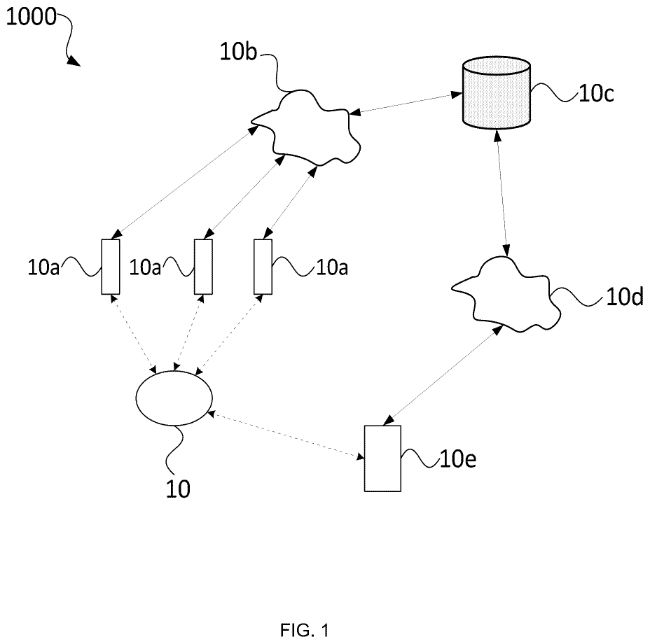

Referring to FIG. 1, an embodiment of the present disclosure illustrates a bell positioning system 1000 that utilizes wireless communication systems and techniques for physical and/or geographical positioning. The positioning system 1000 may include a positioning device, at least one first electronic device 10a, a server 10c, and a second electronic device 10e. In this embodiment, the positioning device may be a bell 10. Thus, the positioning system 1000 is primarily used to locate transportation vehicles such as bicycles, electric bicycles, scooters, or self-balancing vehicles that a user may have inadvertently lost or temporarily lost contact with. These vehicles may be equipped with the bell 10 of the positioning system, and with the aid of the bell 10 and/or the bell positioning system 1000, users can conveniently locate their vehicles, such as a bicycle.

In some examples, the bell 10 may include an antenna for transmitting wireless signals detectable by another electronic device, such as a smartphone. Using the detected wireless signals (and employing positioning techniques such as time-of-flight, received signal strength indication, triangulation, etc.), the smartphone can determine the position of the bell 10 relative to the smartphone and further use the smartphone's absolute position relative to GPS or Earth to determine the absolute position of the bell 10. Here, the absolute position of the bell 10 may refer to its latitude and longitude coordinates relative to Earth.

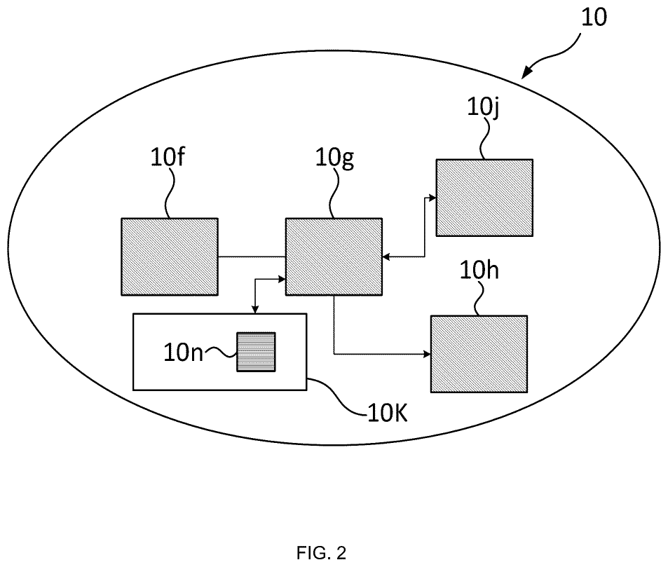

In some examples, referring to FIG. 2, which pertains to the system composition of the bell 10, the bell 10 may include a processor 10g, an antenna 10j coupled to the processor 10g, and an audio system 10h coupled to the processor 10g. In some examples, the antenna 10j transmits wireless signals to other devices (e.g., smartphones, tablets, etc.) that analyze the wireless signals to determine the distance, position, orientation, and/or alignment of the bell 10 with high accuracy. In this disclosure, “positioning” may refer to determining one or more spatial parameters of the bell 10 or other wirelessly locatable devices. Spatial parameters include parameters defining an object's distance, position, orientation, and/or alignment in absolute space or relative to another object, such as the distance between objects, a specific geographic location (e.g., latitude and longitude coordinates), a unit vector from one object to another, or an object's orientation in three-dimensional space (also referred to as angular positioning or attitude).

In some examples, more broadly, the position, orientation, or other spatial parameters of the bell 10 may be determined by any electronic device configured for wireless communication with the bell 10. Exemplary electronic devices include smartphones, tablets, laptops, wireless routers, desktop computers, home automation systems, etc. These electronic devices may update a server or other database with the position of the bell 10. This enhances the ability to locate a lost bell 10 or a vehicle equipped with the bell 10, as a user may query the server or database to determine the bell's position, even if the user is not within the communication range of the bell 10. For instance, when the bell 10 uses Bluetooth for positioning communication, its communication range is approximately 10 meters.

In some examples, for instance, if a user leaves their vehicle (e.g., a bicycle) at home, a desktop computer in the user's home may periodically communicate with the bell 10 within the Bluetooth communication range (or otherwise receive signals from the bell 10) and update a server with the bell's position. Thus, the user can simply request the current position of the bell 10 from the server, even if they are far away and unable to directly communicate with the bell 10 using their smartphone. Additional exemplary use cases and device details are described in this disclosure. Beyond the user's home environment, other devices not associated with the user (e.g., smartphones of other individuals) may also communicate with the bell 10 (or otherwise receive signals from it) to securely and anonymously update the server with the bell's position. This represents a significant improvement of the bell 10 or the positioning system 1000 over existing positioning technologies. More specifically, for example, outside the user's home environment, thousands or even millions of electronic devices (e.g., mobile phones) within the communication range of the bell 10 may communicate with it and report its position securely and anonymously. Any of these numerous electronic devices close enough to the bell 10 to receive signals or communicate with it (e.g., via Bluetooth) can update the server with the bell's position securely and anonymously. Thus, the large number of electronic devices capable of communicating with or receiving signals from the bell 10 effectively forms a robust, multi-redundant device position relay network that continuously (and privately) monitors and updates the positions of numerous individual bells 10.

In some examples, the antenna 10j in the bell 10 may communicate with nearby electronic devices (e.g., 10a) by transmitting periodic wireless signals. Applicable wireless communication protocols for the antenna 10j include near-field communication protocols (e.g., ISO/IEC 14443, ISO/IEC 18092, ISO/IEC 21481), UWB protocols, Bluetooth (e.g., IEEE 802.15), WiFi (e.g., IEEE 802.11), cellular protocols, and Zigbee (IEEE 802.15.4 standard), or any suitable combination thereof. Accordingly, nearby electronic devices (e.g., 10a) may monitor these wireless communication protocols and detect corresponding communication signals within their communication range (e.g., within 20 meters), thereby establishing a communication connection with the bell 10.

In some examples, the antenna 10j may periodically transmit a first wireless signal receivable by one or more first electronic devices 10a within the communication range of the antenna 10j, enabling the first electronic device 10a to determine the position of the bell 10 relative to the first electronic device 10a based on the first wireless signal. For example, the first wireless signal may be a UWB signal. In this disclosure, a “UWB signal” may refer to a signal transmitted over a large portion of the radio spectrum (e.g., with a bandwidth greater than 500 MHz or greater than 20% of the center carrier frequency). Using UWB signals for positioning is referred to herein as “UWB positioning.”

In some examples, the first electronic device 10a responsible for receiving signals (or a device operably coupled to the first electronic device 10a) may analyze UWB signals or UWB signal pulses detected by the first electronic device 10a (e.g., via a UWB antenna inherent to the first electronic device 10a) to determine the distance between the first electronic device 10a and the bell 10 transmitting the UWB signal pulses. Specifically, the first electronic device 10a may determine the time-of-flight (TOF) of the UWB signal pulse and multiply the TOF by the propagation speed of the signal pulse (e.g., the speed of light) to determine or estimate the distance between the bell 10 and the first electronic device 10a.

Alternatively, the first electronic device 10a may determine the TOF by calculating the difference between the transmission time (i.e., the time the signal was transmitted) and the time the signal was detected (also referred to as the time of arrival (TOA)). The transmission time may be included in the detected UWB signal pulse, sent as part of a separate transmission, or known due to a prior synchronization process between the first electronic device 10a and the bell 10.

Using UWB signals to determine distance or position offers numerous advantages, including improved accuracy in determining TOA and/or TOF. For example, UWB signals may have shorter wavelengths than other signals, reducing the time range within which the signal can be detected. This reduces errors in determining TOA and TOF, leading to more accurate distance estimates. In other examples, the antenna 10j transmitting Bluetooth signals using the Bluetooth communication protocol is also a preferred solution.

In some examples, referring to FIG. 1, the first electronic device 10a may use the position of the bell 10 relative to the first electronic device 10a and the position of the first electronic device 10a itself relative to a specific reference frame (e.g., Earth) to determine the position of the bell 10 relative to the specific reference frame (e.g., Earth) and generate a corresponding position report, which is then uploaded to the server 10c via a network 10b (e.g., a 4G communication network). Specifically, the first electronic device 10a (e.g., a smartphone) may include a GPS receiver or be operably coupled to a GPS receiver configured to determine the position of the first electronic device 10a. As described above, in this disclosure, “position” may refer to the geographic point where an electronic device is located, such as a point on the Earth's surface or elsewhere, and may be specified according to a geographic coordinate system (e.g., latitude and longitude) or relative to another geographic point or point of interest. As discussed above, UWB positioning may be used to determine the position of the bell 10 relative to the first electronic device 10a. Thus, by using the position of the first electronic device 10a determined by GPS and the position of the bell 10 relative to the first electronic device 10a determined by UWB positioning, the absolute position of the bell 10 or its position relative to Earth (e.g., including latitude and longitude information) can be determined. In other examples, the first electronic device 10a may determine its own absolute position (relative to Earth) using Beidou satellite positioning, base station positioning (e.g., GSM network), GLONASS, or Galileo systems.

In another example, the first electronic device 10a may use its own position as an estimated position for the bell 10. For instance, if the first electronic device 10a can connect to the bell 10 via Bluetooth, it may be assumed that the bell 10 is within approximately 30 feet (or another distance, depending on Bluetooth communication parameters) of the first electronic device 10a. Thus, for example, the first electronic device 10a may report the position of the bell 10 as an area centered on the first electronic device 10a with a radius corresponding to the communication range of the wireless communication protocol used to communicate with the bell 10 (e.g., 10-100 meters for Bluetooth). In other cases, the first electronic device 10a may determine or estimate the position of the bell 10 more precisely. For example, the first electronic device 10a may use time-of-flight (TOF), angle of arrival (AOA), time difference of arrival (TDOA), received signal strength indication (RSSI), triangulation, synthetic aperture, and/or any other suitable techniques to determine the position of the bell 10 relative to the first electronic device 10a.

In some examples, referring to FIG. 1, the user owning the bell 10 or the vehicle equipped with the bell 10 may use a second electronic device 10e to retrieve the aforementioned position report regarding the bell 10 from the server 10c (e.g., via a 4G network 10d) to locate the bell 10. This allows the user to move to the vicinity of the position provided in the position report to find the bell 10 or the vehicle equipped with the bell 10. Then, as the user approaches the bell 10 or the vehicle equipped with the bell 10—for example, when the user enters the wireless communication range of the bell 10 (e.g., 50 meters)—the antenna 10j in the bell 10 can establish communication with the user's second electronic device 10e (e.g., a mobile phone). More specifically, the antenna 10j may receive a second wireless signal (e.g., a Bluetooth signal) transmitted by the second electronic device 10e, the second wireless signal primarily including instructions for generating sound. In response, the processor 10g in the bell 10 may control the corresponding audio system 10h (e.g., a buzzer) to produce an audible audio output, such as a beep or other audible tone (e.g., a constant tone, a song, etc.), to assist the user in locating/discovering the bell 10 at that moment. It is worth noting that the type of the aforementioned second wireless signal and the first wireless signal may be the same or similar, such as both being Bluetooth signals.

In some examples, as shown in FIG. 2, the aforementioned bell 10 may further include a solar panel 10f at least partially exposed, configured to supply power to at least the processor 10g, the antenna 10j, and the audio system 10h. With the solar panel 10f, the endurance issue of the bell 10 is addressed, eliminating the need for cumbersome user charging operations. The type of the solar panel 10f is not particularly limited and may include, for example, single-junction solar panels (made of monocrystalline or polycrystalline silicon, with conversion efficiencies typically between 15% and 20%), thin-film solar panels (made of amorphous silicon, copper indium gallium selenide, etc., with generally lower conversion efficiencies than single-junction types but lower production costs), multi-junction solar panels (made by stacking photoelectric materials with different band gaps, theoretically achieving conversion efficiencies above 30%), or any suitable combination thereof.

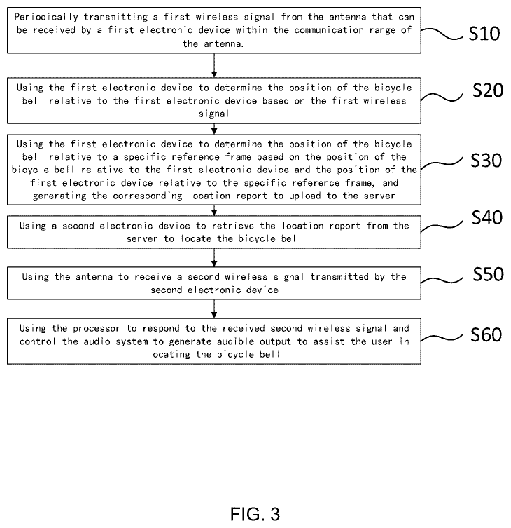

In some examples, referring to FIG. 3, a method for positioning a bell is illustrated, wherein the bell involved may, for example, be the aforementioned bell 10, which may similarly include a processor, an antenna coupled to the processor, and an audio system coupled to the processor. Thus, the steps or processes of the method for positioning the bell may be the same as or similar to the functions configured for the aforementioned bell 10 or its related components (e.g., processor 10g, antenna 10j, audio system 10h). Moreover, the technical effects (benefits) achievable by using this method may be the same as or similar to those achievable by the functions configured for the aforementioned bell 10 or its related components (e.g., processor 10g, antenna 10j, audio system 10h). Specifically, the method may include the following steps:

Step S10: Using the antenna to periodically transmit a first wireless signal receivable by a first electronic device within the communication range of the antenna.

Step S20: Using the first electronic device to determine the position of the bell relative to the first electronic device based on the first wireless signal.

Step S30: Using the first electronic device to determine the position of the bell relative to a specific reference frame (e.g., Earth) based on the position of the bell relative to the first electronic device and the position of the first electronic device itself relative to the specific reference frame, and generating a corresponding position report uploaded to a server.

Step S40: Using a second electronic device to retrieve the aforementioned position report from the server to locate the bell.

Step S50: Using the antenna to receive a second wireless signal transmitted by the second electronic device.

Step S60: Using the processor to control the audio system to produce an audible audio output, such as a beep or other audible tone (e.g., a constant tone, a song, etc.), in response to receiving the second wireless signal to assist the user in locating the bell.

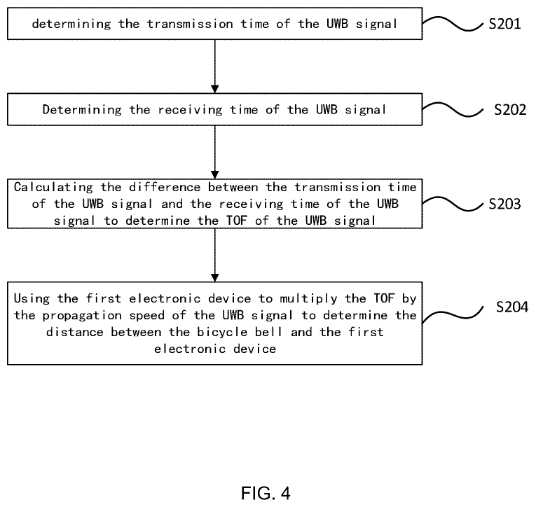

In some examples, referring to FIG. 4, the first wireless signal may be a UWB signal. In this disclosure, a “UWB signal” may refer to a signal transmitted over a large portion of the radio spectrum (e.g., with a bandwidth greater than 500 MHz or greater than 20% of the center carrier frequency). Using UWB signals for positioning is referred to herein as “UWB positioning.” Referring to FIG. 4, therefore, the first electronic device 10a, in performing step S20, may further include the following steps:

Step S201: Determining the transmission time of the UWB signal.

Step S202: Determining the reception time of the UWB signal.

Step S203: Calculating the difference between the transmission time of the UWB signal and the time of receiving the UWB signal to determine the TOF of the UWB signal.

Step S204: Using the first electronic device to multiply the TOF by the propagation speed of the UWB signal to determine the distance between the bell and the first electronic device.

Using UWB signals to determine distance or position offers numerous advantages, including improved accuracy in determining TOA and/or TOF. For example, UWB signals may have shorter wavelengths than other signals, reducing the time range within which the signal can be detected. This reduces errors in determining TOA and TOF, leading to more accurate distance estimates. In other examples, the antenna 10j transmitting Bluetooth signals using the Bluetooth communication protocol is also a preferred solution. Continuing with FIG. 2, the bell 10 of this embodiment further includes a memory 10K coupled to the processor 10g and a program (or instructions) 10n stored in the memory 10K and executable on the aforementioned processor 10g. The processor 10g in the bell 10, when executing the program 10n, can implement the relevant steps of the exemplary method described above, such as at least steps S10 and S60.

Those skilled in the art will appreciate that the system composition diagram of FIG. 2 is merely an example of the system composition of the bell 10 and does not limit the system composition of the bell 10. It may include more or fewer components than shown in FIG. 2, or combine certain components, or have different components, such as including input/output devices, network access devices, etc.

The so-called processor 10g may be a Central Processing Unit (CPU), and the processor 10g may also be other general-purpose processors, Digital Signal Processors (DSPs), Application Specific Integrated Circuits (ASICs), Field-Programmable Gate Arrays (FPGAs), or other programmable logic devices, discrete gate or transistor logic devices, discrete hardware components, etc. A general-Purpose processor may be a microprocessor, or the processor may be any conventional processor.

In some embodiments, the memory 10K may be an internal storage unit of the bell 10, such as a hard disk or memory of the bell 10. In other embodiments, the memory 10K may also be an external storage device of the bell 10, such as a plug-in hard disk, a Smart Media Card (SMC), a Secure Digital (SD) card, a Flash Card, etc., equipped on the bell 10. The memory 10K may be used to store operating systems, application programs or instructions, bootloaders, data, and other program codes, etc. The memory 10K may also be used to temporarily store data that has been output or is to be output.

Those skilled in the art will clearly understand that, for convenience and brevity of description, the program 10n executable by the processor 10g may constitute various software functional units or modules. In practical applications, the above functions may be assigned to different functional units or modules as needed, i.e., the internal structure of the device may be divided into different functional units or modules to perform all or part of the functions described above. The functional units or modules in the embodiments may be integrated into one processing unit, or each unit may exist physically separately, or two or more units may be integrated into one unit.

In other examples, the above software functional units or modules may also be implemented in hardware form. Additionally, the specific names of each functional unit or module are only for ease of distinction and are not intended to limit the scope of protection of this application. The specific working processes of the units or modules in the above system may refer to the corresponding processes in the foregoing method embodiments and will not be repeated here.

The embodiments of this application also provide a computer-readable storage medium storing a computer program, which, when executed by a processor, can implement the relevant steps in the method embodiments described above. The embodiments of this application provide a computer program product that, when running on the bell 10, enables the bell 10 to perform the relevant steps in the method embodiments described above, such as steps S10 and S60.

When the program 10n executable by the processor 10g or similar software functional units or modules are sold or used as a standalone product (e.g., a computer program product), these computer program products may be stored in a computer-readable storage medium. Based on this understanding, all or part of the processes in the methods of the above embodiments of the present disclosure may be accomplished by instructing or controlling related hardware through a computer program, which may be stored in a computer-readable storage medium. When executed by a processor, the computer program can implement the steps of the various method embodiments described above. The computer program includes computer program code, which may be in source code form, object code form, executable file form, or some intermediate form, etc. The computer-readable medium may include at least: any entity or device capable of carrying the computer program code to a photographing device/terminal device, recording medium, computer memory, Read-Only Memory (ROM), Random Access Memory (RAM), electrical carrier signals, telecommunication signals, and software distribution media, such as USB flash disk, portable hard drives, magnetic disks, or optical disks.

Those of ordinary skill in the art will recognize that the units and algorithm steps of the examples described in connection with the embodiments disclosed herein can be implemented by electronic hardware, or a combination of computer software and electronic hardware. Whether these functions are performed in hardware or software depends on the specific application and design constraints of the technical solution. Skilled artisans may use different methods to implement the described functions for each specific application, but such implementations should not be considered beyond the scope of this application.

### First Embodiment

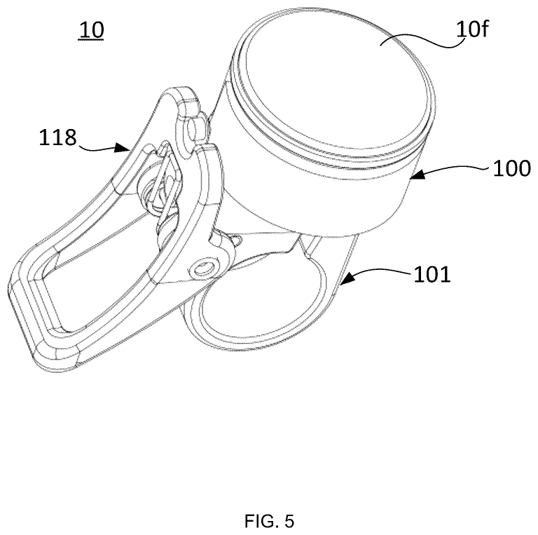

Referring to FIG. 1 or FIG. 5, an embodiment of the present disclosure relates to a specific structure/configuration of a positioning device, which may be a bell 10. The bell 10 can generally be mounted on transportation vehicles such as bicycles, electric bicycles, scooters, etc. Specifically, the bell 10 is provided with a mounting hole 1, which allows the bell 10 to be mounted, for example, on the front handlebar of a bicycle. The bell 10 has a positioning function. For instance, if a bicycle equipped with the bell 10 is inadvertently lost by the user, and the lost position is very far from the user (e.g., 30 kilometers away), the bell 10 can communicate with a mobile terminal near the bell 10. The mobile terminal can determine the position of the bell 10 and report and/or upload the position information of the bell 10 to a corresponding server 10c. The user can then retrieve the position information of the bell 10 from the server 10c, thereby locating the bell 10 and the bicycle equipped with it. It is worth noting that the aforementioned mobile terminal may be an electronic device with built-in GPS communication capabilities, such as a laptop computer, desktop computer, phone (e.g., mobile phone, conventional cordless phone), tablet, watch, earphones, or wearable electronic device.

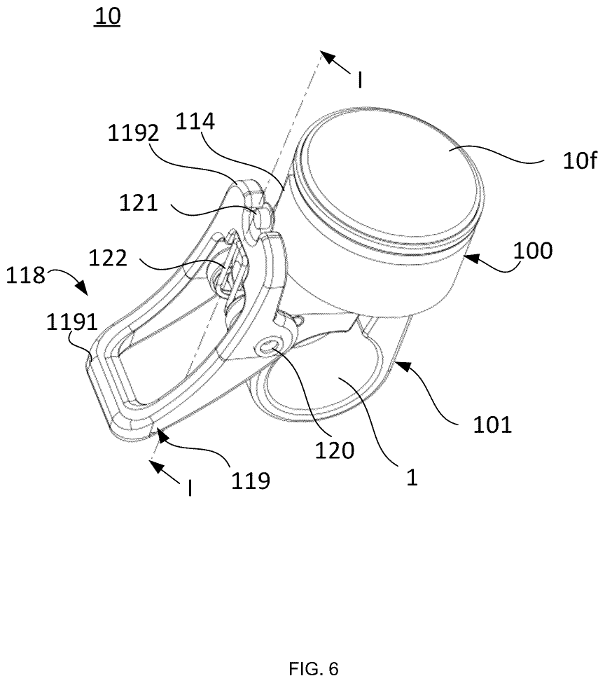

In some embodiments, referring to FIGS. 5-8, the bell 10 may include a housing 100 and a base 101, with the housing 100 mechanically coupled to the base 101, for example, via screws 102 or similar mechanical fasteners to achieve fixed coupling or connection. In this embodiment, the housing 100 and the base 101 constitute the main body or support framework of the bell 10. The shape of the housing 100 is not particularly limited, but preferably, it may be substantially cylindrical. In other examples, the housing 100 may be cubic. The manufacturing material of the housing 100 is not particularly limited; for example, the housing 100 may be made of metal, plastic, glass, wood, composite materials, fiber-reinforced materials, or a combination thereof. Preferably, for instance, the housing 100 may be made of ABS plastic or nylon plastic. In the bell 10, the housing 100 serves as a mounting platform, providing mounting surfaces or cavities, particularly for installing relevant electrical components within corresponding cavities in the housing 100.

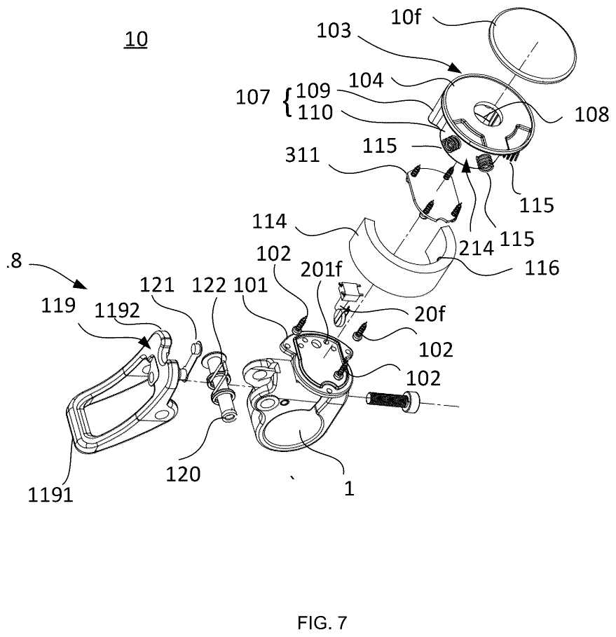

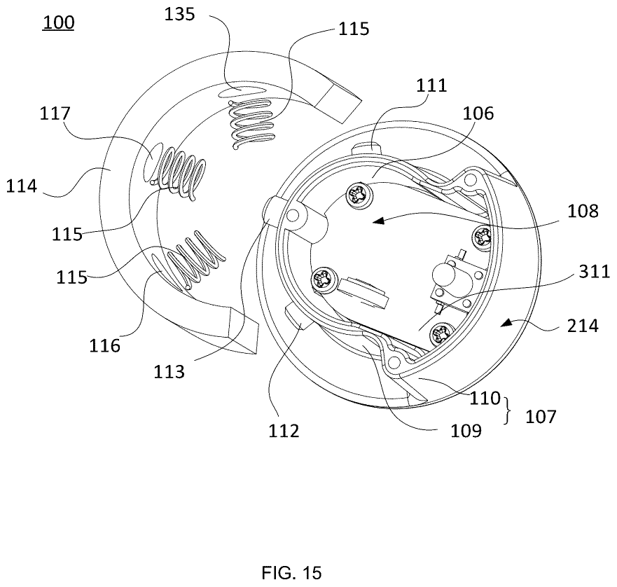

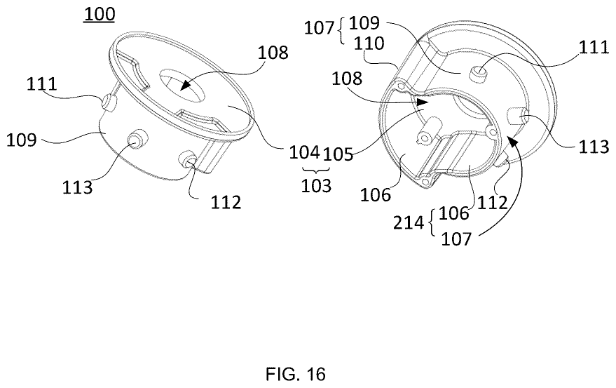

In some embodiments, referring to FIG. 7, FIG. 15, or FIG. 16, the housing 100 may have a top portion 103 and a peripheral side portion 214, wherein the top portion 103 may include a top outer surface 104 and a top inner surface 105, and the peripheral side portion 214 may include an inner surface 106 and an outer surface 107. In this embodiment, the top outer surface 104 is fixedly connected to the solar panel 10f. In this embodiment, the solar panel 10f is mounted to the exterior of the housing 100. In other examples, the solar panel 10f may be partially mounted on the exterior of the housing 100. The specific method of fixed connection is not particularly limited and may include adhesive bonding, inlay connection, screw connection, etc. Preferably, for example, the solar panel 10f may be fixed to the top outer surface 104 by adhesive inlay. The shape of the top outer surface 104 is not particularly limited and may be substantially circular. In other examples, the top outer surface 104 may be square. In this embodiment, the top inner surface 105 and the inner surface 106 of the peripheral side portion together define or substantially enclose a receiving cavity 108. Specifically, the shape and volume of the receiving cavity 108 are not specifically limited. In other examples, the number of receiving cavities may be two or more.

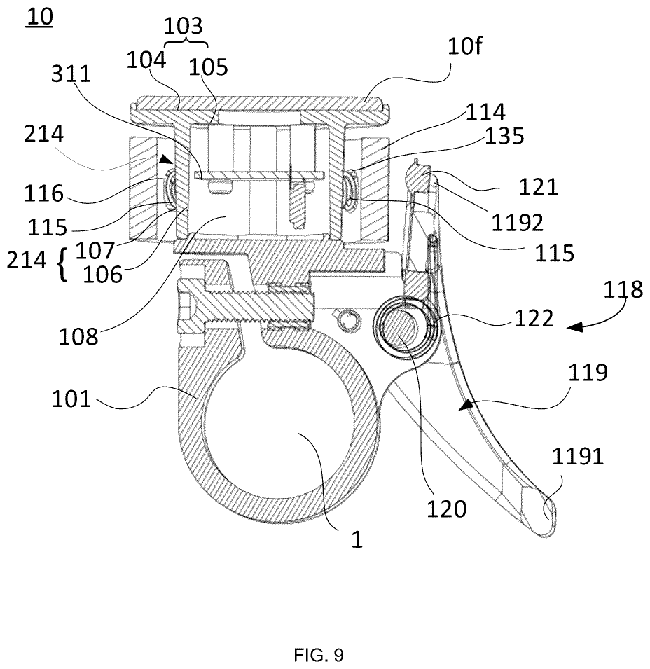

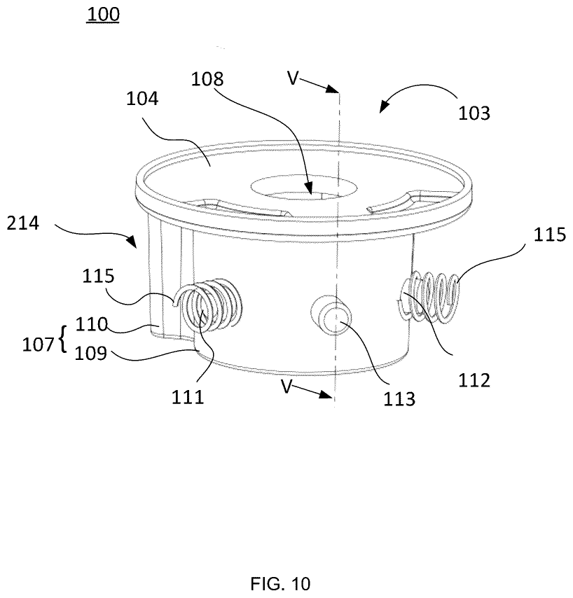

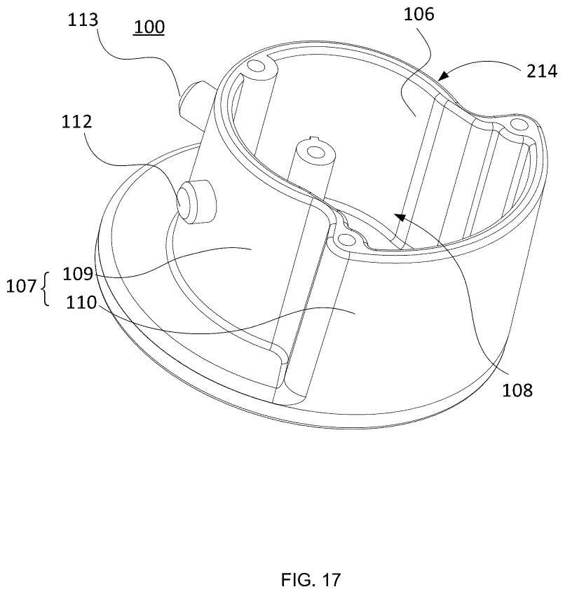

Referring to FIGS. 9-17, in the housing 100, the outer surface 107 of the peripheral side portion 214 may include a first outer surface 109 having a first average curvature radius R1 and a second outer surface 110 having a second average curvature radius R2 greater than the first average curvature radius R1. The first outer surface 109 extends with a first post 111 and a second post 112 spaced apart. Specifically, a third post 113 extends between the first post 111 and the second post 112 at an interval. In this embodiment, the first post 111, the second post 112, and the third post 113 are elastically connected to a sound component 114. Preferably, the connection may be achieved through an elastic member 115, which may be implemented as a spring.

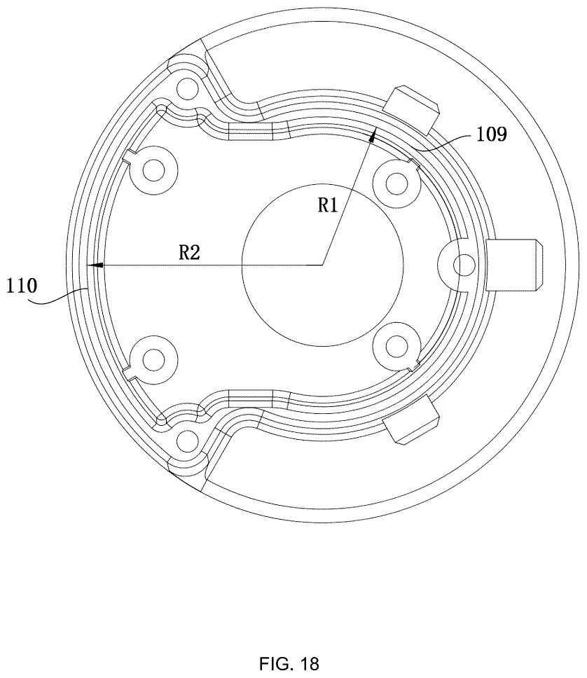

Referring to FIGS. 5-18, in some embodiments, the sound component 114 is entirely mounted on the exterior of the housing 100. The sound component 114 is elastically mounted on the outer surface 107 of the peripheral side portion 214 of the housing 100. Specifically, the sound component 114 may be directly elastically mounted on the first outer surface 109 via a spring. The first end of the spring is fixedly connected to the sound component 114, and the second end of the spring, opposite the first end, is connected to the first outer surface 109. Specifically, the elastic member 115 may be a spring, rubber, etc. Preferably, the elastic member 115 is a spring. The material of the sound component 114 may be ceramic, brass, aluminum, or a combination thereof. Preferably, the material of the sound component may be ceramic. In other examples, the sound component 114 may be partially mounted on the exterior of the housing 100, as long as the relevant striking component can strike the sound component 114 to produce a bell sound.

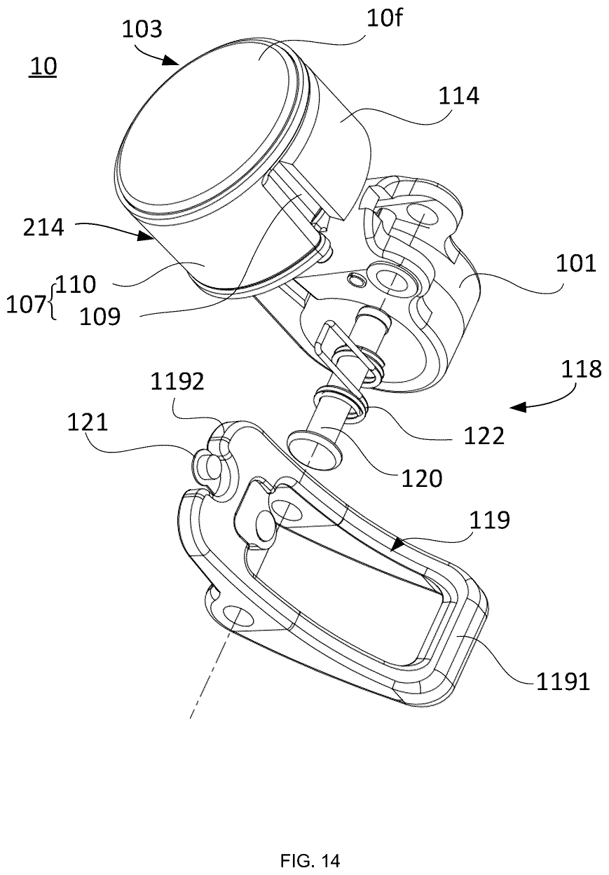

In some embodiments, referring to FIGS. 14-17, the sound component 114 may be elastically connected to the outer surface 107 of the peripheral side portion 214. The shape of the sound component 114 is not particularly limited; in this embodiment, it may be a semicircular ring with a certain thickness. In other examples, the shape of the sound component 114 may be square. In this embodiment, the radius of the sound component 114 and the radius of the second outer surface 110 are exactly equal to the radius of the circular top portion 103. In some other embodiments, the average curvature radius of the sound component 114 and/or the radius of the second outer surface 110 may be greater than the radius of the top portion 103. In other embodiments, the radius of the sound component 114 and/or the radius of the second outer surface 110 may be less than the radius of the top portion 103.

Specifically, the inner surface of the sound component 114 may be provided with a first slot 135 aligned with the first post 111 and a second slot 116 aligned with the second post 112, with a third slot 117 aligned with the third post 113 disposed between the first slot 135 and the second slot 116. In this embodiment, the number of slots provided on the inner surface of the sound component 114 is not particularly limited; preferably, it may be three slots. In some embodiments, it may be two slots. The spacing of the slots provided on the inner surface of the sound component 114 is not particularly limited; preferably, they may be three equally spaced slots. In some embodiments, they may be two symmetrically spaced slots. The shape of the slots provided on the inner surface of the sound component 114 is also not particularly limited; preferably, they may be circular slots. In some embodiments, they may be elliptical. In some embodiments, they may be polygonal. In this embodiment, the user may cause the sound component 114 to produce a bell sound in response to a striking component 118 through a striking action.

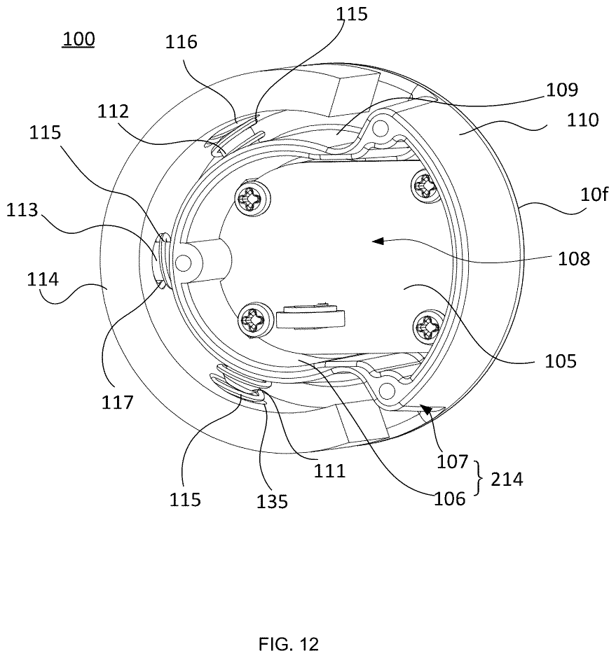

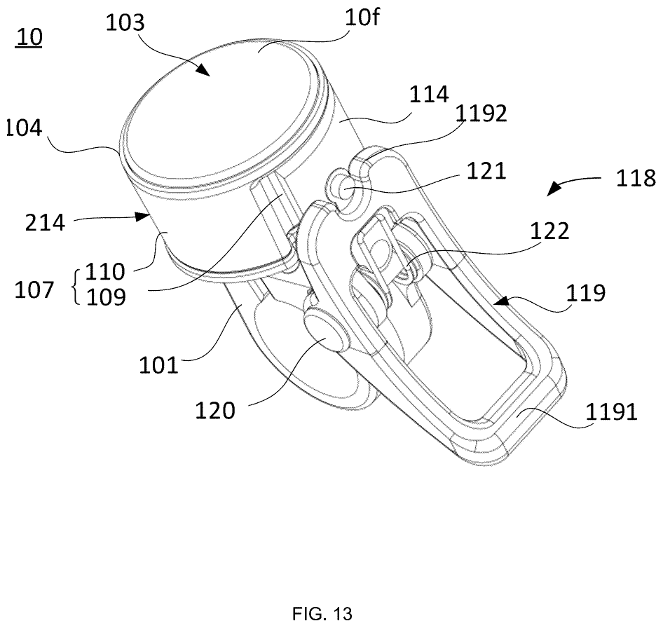

In some embodiments, referring to FIGS. 12-13, the striking component 118 may be pivotally mounted on the fixed base 101. Specifically, the striking component 118 may include a striking member 119, a pivot shaft 120, a contact member 121, and a return torsion spring 122. The pivot shaft 120 is movably mounted on the striking member 119, while the contact member 121 is fixedly mounted on the striking member 119 for contacting the sound component 114 to produce a bell sound. The return torsion spring 122 is provided on the pivot shaft 120 to reset and rebound the striking member 119 after it contacts the sound component 114. The striking member includes a first end 1191 and a second end 1192, with the contact member 121 mounted on the second end 1192. When the user presses (e.g., with a finger) the first end 1191, the second end 1192 lifts; when the user releases the finger, the second end 1192 rebounds under the action of the return torsion spring 122, striking the sound component 114 to produce a loud bell sound. In this embodiment, the striking component 119 is configured to perform a striking action in response to the user's hand operation. The user's hand contacts the striking member 119, causing the striking member to drive the contact member 121 to contact the sound component 114, completing the striking action, whereby the first sound component responds to the striking action to produce a first sound. The first sound component is elastically mounted on the outer surface 107 of the peripheral side portion 214 of the housing 100.

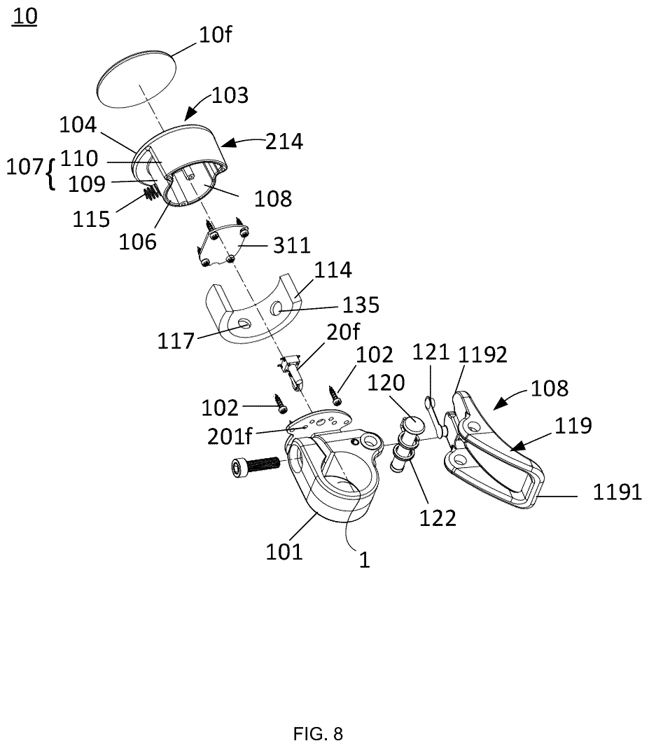

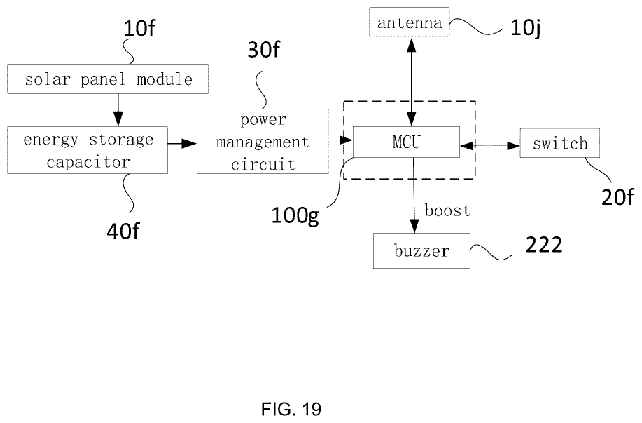

In some embodiments, referring to FIG. 2, FIG. 7, FIG. 8, or FIG. 19, which illustrate some electrical connection relationships within the bell 10, some electrical components inside the bell 10 may further include a switch 20f, an energy storage capacitor 40f, a solar panel 10f, a battery management module 30f, a processor 10g, an antenna 10j, and a buzzer 222. The energy storage capacitor 40f may be used to store electrical energy from the solar panel 10f. In this embodiment, the solar panel 10f may supply power to the MCU 100g, the antenna 10j, and other systems, while the power management module 30f may be configured to receive power from the solar panel 10f and supply it to modules such as the MCU 100g. Specifically, the power management module 30f may also monitor parameters such as the health status (leakage, impedance) of the energy storage capacitor 40f. Specifically, the processor 10g may be integrated into an MCU. In this embodiment, the processor 10g may be coupled to the solar panel 10f. Specifically, the MCU 100g may control the corresponding audio system 10h to produce an audible audio output for assisting the user in locating/discovering the bell 10 in response to receiving the second wireless signal. Specifically, the audio output may be a beep, a constant tone, a song, or other audible tones. In this embodiment, preferably, the audio system may be a buzzer 222, which serves as the second sound component. Specifically, the buzzer 222 may be coupled to the processor 10g. The switch 20f may control the on/off state of the bell's communication operations, and the switch 20f is specifically a push-type switch component. Specifically, multiple sound emission holes 201f are provided near the switch 20f to facilitate the outward emission of sound from the buzzer 222. The antenna 10j may be configured to periodically receive and transmit wireless signals within its communication range.

In some embodiments, referring to FIG. 1, FIG. 2, FIG. 7, FIG. 8, or FIG. 19, the bell 10 may further include a circuit board 311. The circuit board may be mounted within the receiving cavity 108. Specifically, the circuit board 311 may include a controller, an energy storage component, a communication component, and a second sound component. The energy storage component may be an energy storage capacitor 40f, the second sound component may be a buzzer 222, and the controller may be integrated with a processor 10g. In this embodiment, the controller may be an MCU 100g (microcontroller). Specifically, the processor 10g and the communication component are both mounted inside the housing 100. In this embodiment, the communication component may include a communication circuit coupled to the processor 10g and having an antenna 10j. The communication component is coupled to the MCU 100g. Specifically, the communication component is configured to periodically transmit a first wireless signal receivable by the first electronic device 10a. Preferably, the first wireless signal may be a UWB signal. The first electronic device 10a is configured to locate the bell 10 based on the first wireless signal and to receive a second wireless signal transmitted by the second electronic device 10e. The MCU 100g is configured to control the second sound component to produce a second sound for assisting the user in locating the bell 10 based on the second wireless signal.

### Second Embodiment

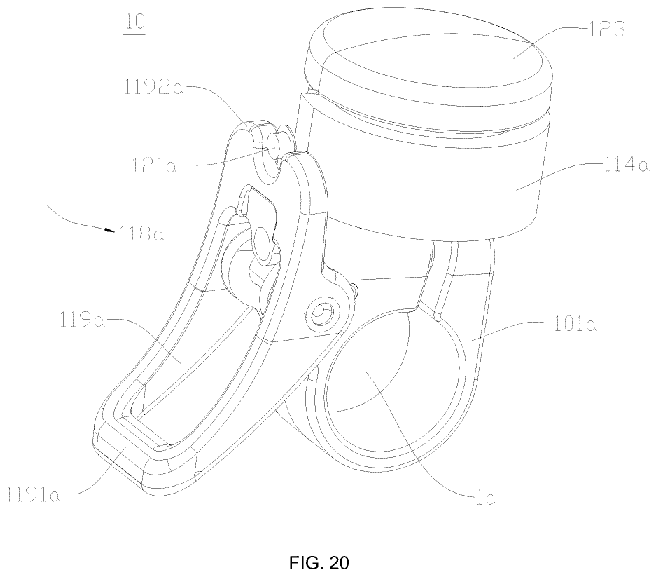

In some embodiments, as shown in FIGS. 20-27, an embodiment of the present disclosure relates to another specific structure/configuration of a bell. The bell 10 includes a body, a striking component 118a, a sound component 114a, a cover 123, and a positioning apparatus 130. The body includes a housing 100a and a fixed base 101a connected to the housing 100a, the fixed base 101a being configured to fixedly connect the bell 10 to a vehicle, with the side of the housing 100a facing away from the fixed base 101a being open. The striking component 118a is mounted on the body and configured to perform a striking action in response to a user's hand operation. The sound component 114a is mounted on the body and configured to produce a bell sound in response to the striking action. The cover 123 is disposed over an open end 124 of the housing 100a, and the cover 123 and the housing 100a together define a first chamber 125. The positioning apparatus 130 is mounted within the first chamber 125 and configured to communicatively connect with an electronic device to enable the electronic device to locate the vehicle. In this embodiment, by mounting the positioning apparatus 130 within the first chamber 125, the concealment of the positioning apparatus 130 is enhanced, preventing it from being discovered and removed, ensuring that the user can track and monitor the position of the bell 10 and/or the vehicle in real time, thereby providing a good anti-theft effect. In some examples, the positioning apparatus 130 can be entirely replaced by an AirTag locator manufactured by Apple Inc.

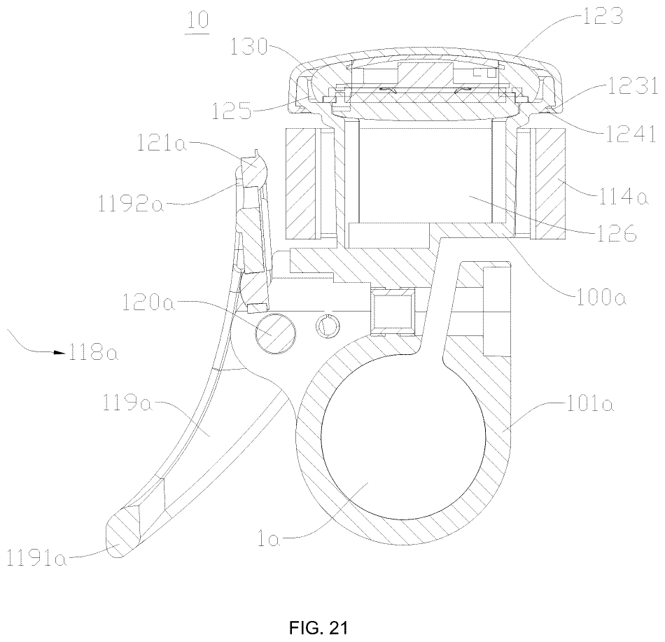

Specifically, as shown in FIGS. 20 and 21, the fixed base 101a is provided with a mounting hole 1a, which allows the bell 10 to be mounted, for example, on the front handlebar of a bicycle. The positioning apparatus 130 has a positioning function. For instance, if a bicycle equipped with the bell 10 is inadvertently lost by the user, and the lost position is very far from the user (e.g., 30 kilometers away), the bell 10 can communicate with a mobile terminal near the bell 10. The mobile terminal can determine the position of the bell 10 and report and/or upload the position information of the bell 10 to a corresponding server 10c. The user can then retrieve the position information of the bell 10 from the server 10c, thereby locating the bell 10 and the bicycle equipped with it. It is worth noting that the aforementioned mobile terminal may be an electronic device with built-in GPS communication capabilities, such as a laptop computer, desktop computer, phone (e.g., mobile phone, conventional cordless phone), tablet, watch, earphones, or wearable electronic device.

In some embodiments, the housing 100a and the fixed base 101a are integrally formed, thereby increasing the structural strength of the bell 10, simplifying the manufacturing process, and improving production efficiency. The housing 100a and the fixed base 101a constitute the main body or support framework of the bell 10. The shape of the housing 100a is not particularly limited; preferably, it may be substantially cylindrical. In other examples, the housing 100a may be cubic. The manufacturing material of the housing 100a is not particularly limited; for example, the housing 100a may be made of metal, plastic, glass, wood, composite materials, fiber-reinforced materials, or a combination thereof. Preferably, for instance, the housing 100a may be made of ABS plastic or nylon plastic.

In other examples, the housing 100a and the fixed base 101a may be mechanically coupled, for example, via screws or other mechanical fasteners to achieve fixed coupling or connection.

In some embodiments, referring to FIGS. 21-23, the housing 100a is provided with a second chamber 126 communicating with the first chamber 125. The inner diameter of the first chamber 125 is greater than the inner diameter of the second chamber 126, forming a step portion 127 between the first chamber 125 and the second chamber 126. The side of the positioning apparatus 130 facing away from the cover 123 is supported on the step portion 127. Specifically, the second chamber 126 is formed inside the housing 100a, and the first chamber 125 is formed at the open end 124 of the housing 100a. Both the first chamber 125 and the second chamber 126 may be configured as cylindrical cavity structures. In this embodiment, the shape and size of the first chamber 125 match the shape and size of the positioning apparatus 130. When the cover 123 is placed over the housing 100a, one side of the positioning apparatus 130 abuts the step portion 127, and the other side abuts the inner side of the cover 123, thereby retaining the positioning apparatus 130 within the first chamber 125 and preventing relative displacement within the first chamber 125, further enhancing the concealment of the positioning apparatus 130. Additionally, in this embodiment, providing the second chamber 126 helps reduce the weight of the bell 10 and the material consumption of the housing 100a, thereby lowering production costs.

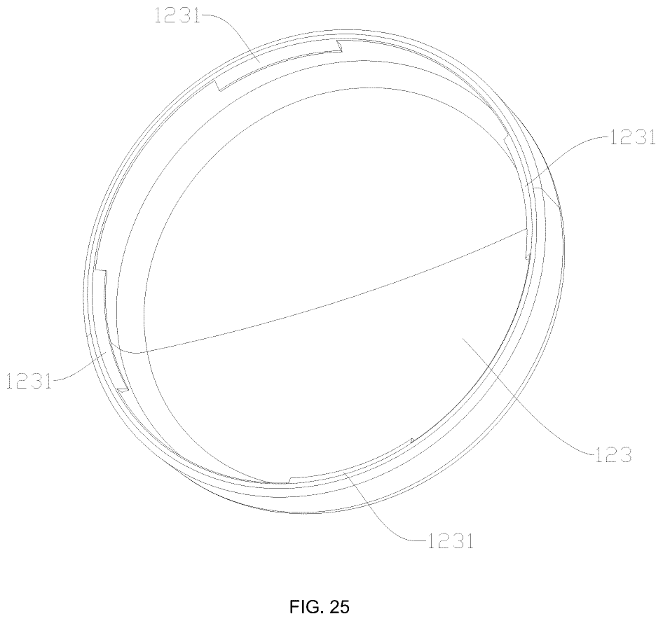

In some embodiments, referring to FIGS. 21 and 25, a fastening portion 1231 is provided at the inner edge of the cover 123, and an annular groove 1241 is provided at the open end 124 of the housing 100a, with the fastening portion 1231 adapted to snap into the annular groove 1241. For example, the housing 100a may be made of plastic, and the fastening portion 1231 may include multiple snap structures spaced along the inner edge of the cover 123. Due to the deformable nature of plastic, in this embodiment, simply pressing the cover 123 allows the fastening portion 1231 of the cover 123 to snap into the annular groove 1241 of the housing 100a, providing a simple and reliable operation. When the cover 123 needs to be removed, applying a force in the opposite direction enables disassembly, facilitating replacement or repair of the positioning apparatus.

In other embodiments, the fastening portion 1231 may also be an annular rib provided at the inner edge of the cover 123. By pressing the cover 123, the cover 123 undergoes elastic deformation, allowing the annular rib to be installed in the annular groove 1241, providing a good fixing effect.

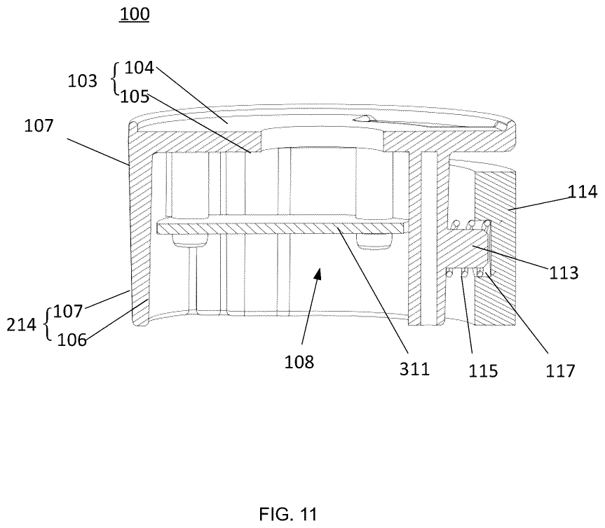

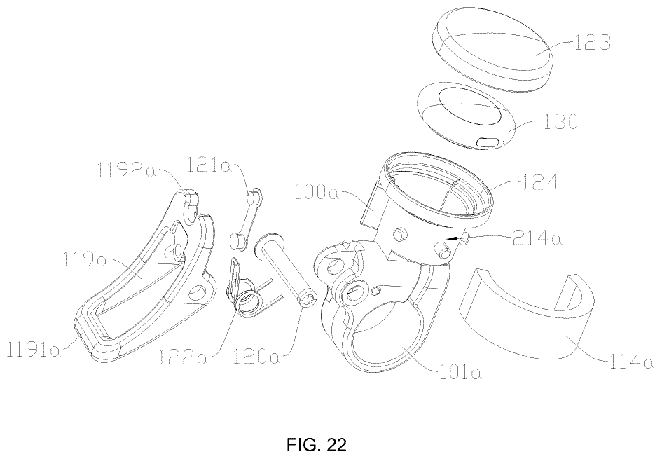

In some embodiments, referring to FIGS. 22-24, the housing 100a has a peripheral side portion 214a, and the outer surface of the peripheral side portion 214a may include a first outer surface 109a having a first average curvature radius R1 and a second outer surface 110a having a second average curvature radius R2 greater than the first average curvature radius R1. The first outer surface 109a extends with a first post 111a and a second post 112a spaced apart. Specifically, a third post 113a extends between the first post 111a and the second post 112a at an interval. In this embodiment, as shown in FIG. 11, the first post 111a, the second post 112a, and the third post 113a are connected to the sound component 114a via elastic members 115a. Preferably, the connection may be achieved through corresponding first, second, and third elastic members, each of which may be implemented as a spring or rubber.

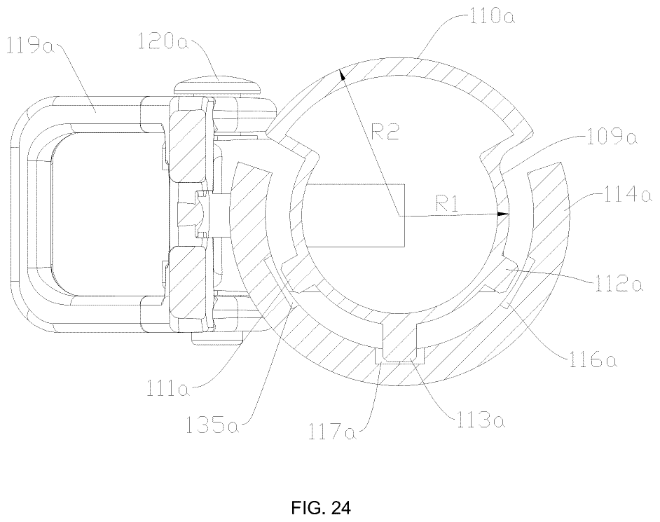

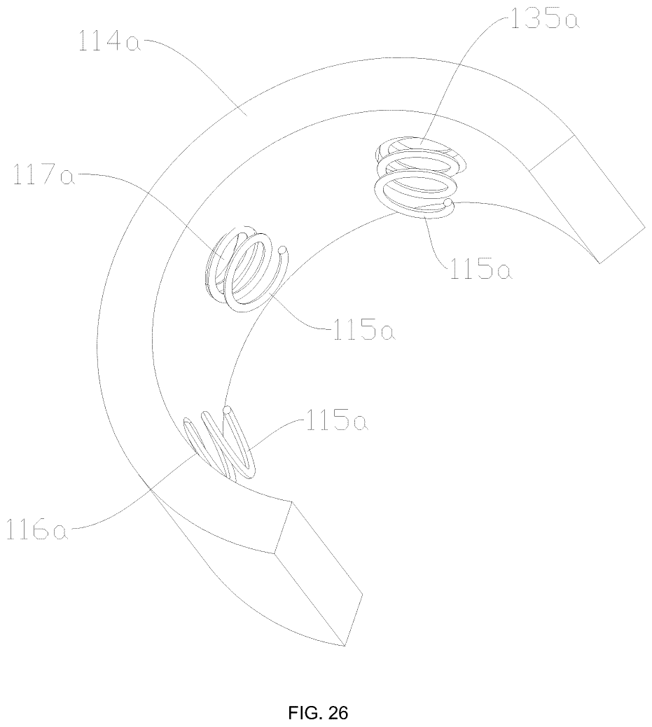

In some embodiments, referring to FIGS. 24 and 26, the sound component 114a is entirely mounted on the exterior of the housing 100a. The sound component 114a may be directly elastically mounted on the first outer surface 109a via a spring. The first end of the spring is fixedly connected to the sound component 114a, and the second end of the spring, opposite the first end, is connected to the first outer surface 109a. The material of the sound component 114a may be ceramic, brass, aluminum, or a combination thereof. Preferably, the material of the sound component 114a may be ceramic. In other examples, the sound component 114a may be partially mounted on the exterior of the housing 100a, as long as the relevant striking component 118a can strike the sound component 114a to produce a bell sound.

In some embodiments, referring to FIG. 24, the sound component 114a may be elastically connected to the first outer surface 109a. The shape of the sound component 114a is not particularly limited; in this embodiment, it may be a semicircular ring with a certain thickness. In other examples, the shape of the sound component 114a may be square. In this embodiment, the radius of the sound component 114a is exactly equal to the radius of the second outer surface 110a. In some other embodiments, the average curvature radius of the sound component 114a may be greater than the radius of the second outer surface 110a. In other embodiments, the radius of the sound component 114a may be less than the radius of the second outer surface 110a.

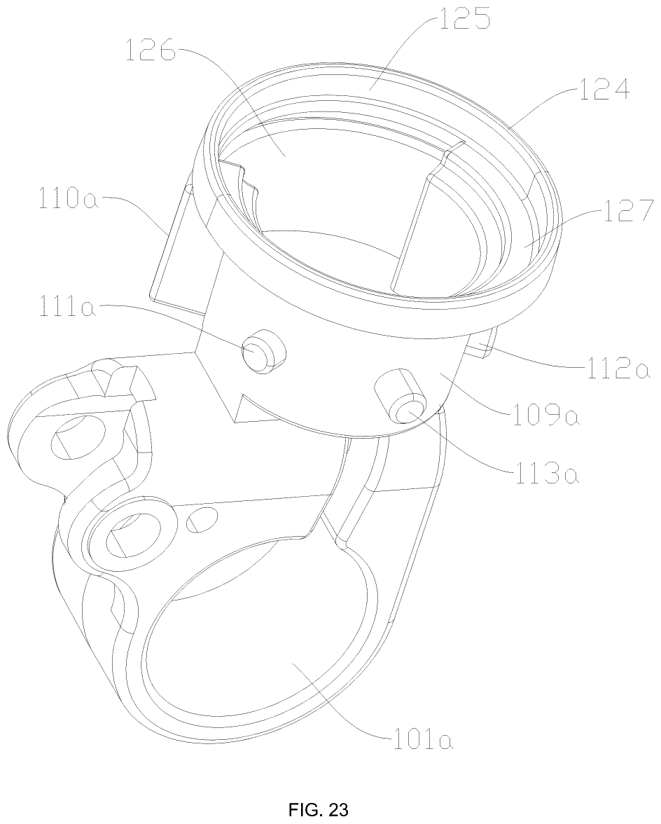

Specifically, referring to FIGS. 23 and 24, the inner surface of the sound component 114a may be provided with a first slot 135a aligned with the first post 111a and a second slot 116a aligned with the second post 112a, with a third slot 117a aligned with the third post 113a disposed between the first slot 135a and the second slot 116a. In this embodiment, the number of slots provided on the inner surface of the sound component 114a is not particularly limited; preferably, it may be three slots. In some embodiments, it may be two slots. The spacing of the slots provided on the inner surface of the sound component 114a is not particularly limited; preferably, they may be three equally spaced slots. In some embodiments, they may be two symmetrically spaced slots. The shape of the slots provided on the inner surface of the sound component 114a is also not particularly limited; preferably, they may be circular slots. In some embodiments, they may be elliptical. In some embodiments, they may be polygonal. In this embodiment, the user may cause the sound component 114a to produce a bell sound in response to a striking component 118a through a striking action.

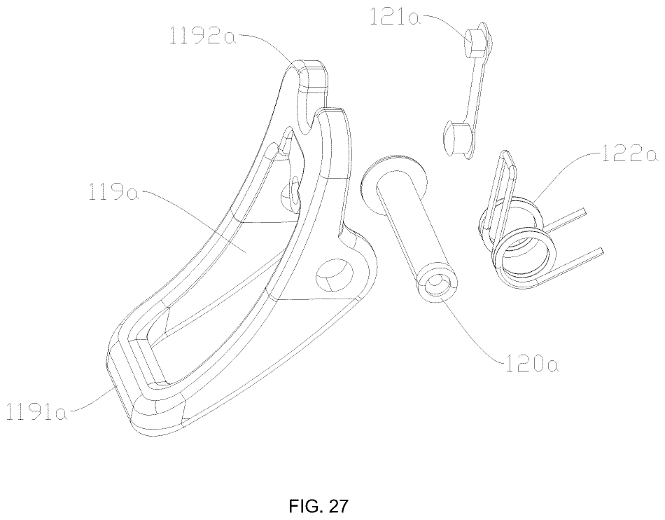

In some embodiments, referring to FIGS. 20 and 27, the striking component 118a may be pivotally mounted on the fixed base 101a. Specifically, the striking component 118a may include a striking member 119a, a pivot shaft 120a, a contact member 121a, and a return torsion spring 122a. The pivot shaft 120a is movably mounted on the striking member 119a, while the contact member 121a is fixedly mounted on the striking member 119a for contacting the sound component 114a to produce a bell sound. The return torsion spring 122a is provided on the pivot shaft 120a to reset and rebound the striking member 119a after it contacts the sound component 114a. The striking member 119a includes a first end 1191a and a second end 1192a, with the contact member 121a mounted on the second end 1192a. When the user presses (e.g., with a finger) the first end 1191a, the second end 1192a lifts; when the user releases the finger, the second end rebounds under the action of the return torsion spring 122a, striking the sound component 114a to produce a loud bell sound 10. In this embodiment, the striking component 118a is configured to perform a striking action in response to the user's hand operation. The user's hand contacts the striking member 119a, causing the striking member 119a to drive the contact member 121a to contact the sound component 114a, completing the striking action, whereby the sound component 114a responds to the striking action to produce a sound.

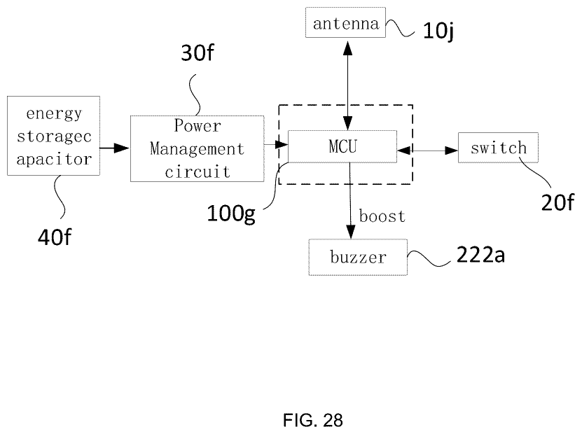

In some embodiments, referring to FIG. 28, which illustrates some electrical connection relationships within the positioning apparatus 130, some electrical components inside the bell 10 may further include a switch 20f, a battery 40f, a battery management module 30f, a processor 10g, an antenna 10j, and a buzzer 222a. In this embodiment, the battery 40f may supply power to the MCU 100g, the antenna 10j, and other systems, while the power management module 30f may be configured to receive power from the battery 40f and supply it to modules such as the MCU 100g. Specifically, the power management module 30f may also monitor parameters such as the health status (leakage, impedance) of the battery 40f. Specifically, the MCU 100g may control the corresponding audio system 10h to produce an audible audio output for assisting the user in locating/discovering the bell 10 in response to receiving the second wireless signal. Specifically, the audio output may be a beep, a constant tone, a song, or other audible tones. In this embodiment, preferably, the audio system may be a buzzer 222a. The switch 20f may control the on/off state of the bell 10's communication operations, and the switch 20f is specifically a push-type switch component. Specifically, multiple sound emission holes are provided near the switch 20f to facilitate the outward emission of sound from the buzzer 222a. The antenna 10j may be configured to periodically receive and transmit wireless signals within its communication range.

In some embodiments, the positioning apparatus 130 further includes a circuit board. Specifically, the circuit board is integrated with a controller, an energy storage component, a communication component, and a buzzer 222a. The energy storage component may be a battery 40f, and in this embodiment, the controller may be an MCU 100g (microcontroller). In this embodiment, the communication component may include a communication circuit coupled to the processor and having an antenna 10j. The communication component is coupled to the MCU 100g. Specifically, the communication component is configured to periodically transmit a first wireless signal receivable by the first electronic device 10a. Preferably, the first wireless signal may be a UWB signal. The first electronic device 10a is configured to locate the bell 10 based on the first wireless signal and to receive a second wireless signal transmitted by the second electronic device 10e. The MCU 100g is configured to control the buzzer 222a to produce a sound for assisting the user in locating the bell 10 based on the second wireless signal.

The type of the battery 40f is not limited and may be, for example, a rechargeable battery or a disposable battery. More specifically, the battery 40f may be: a Coin/Button Cell Lithium-ion Battery, such as models CR2032, CR2025, CR2450, etc.; a Small Cylindrical Lithium-ion Battery, such as models 14500, 16340, 10440, etc.; a Small Pouch/Polymer Lithium-ion Battery, a pouch battery with customizable shapes and sizes; a Lithium Thionyl Chloride Battery (Li-SOCl2), a lithium primary battery that is non-rechargeable; or a Solid-State Thin-Film Battery, a fully solid-state battery that can be made extremely thin.

### Third Embodiment

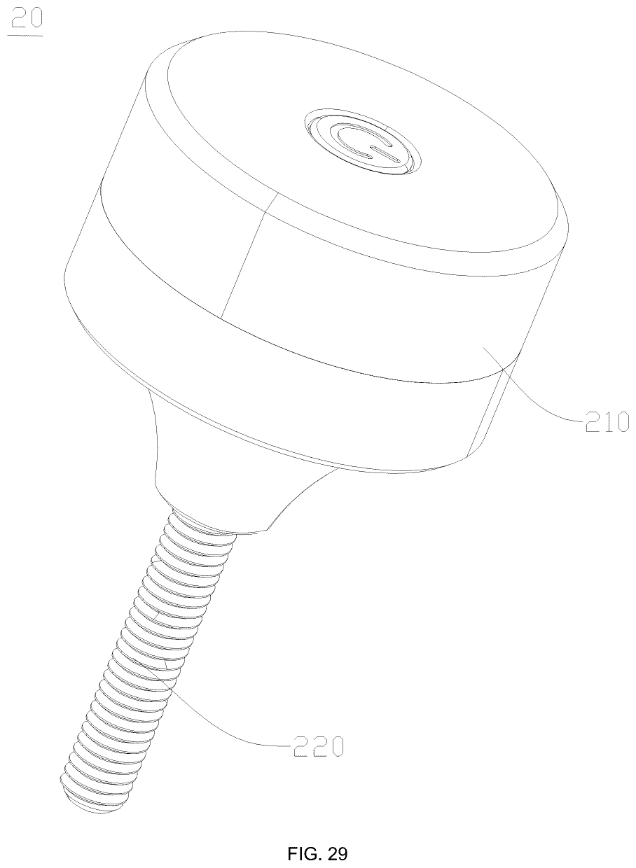

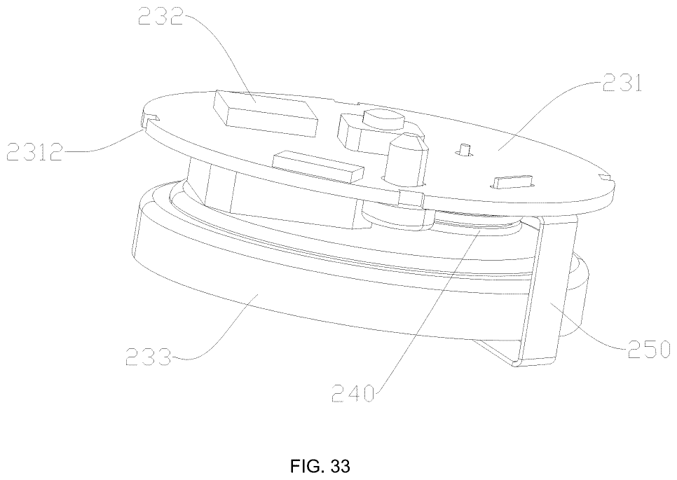

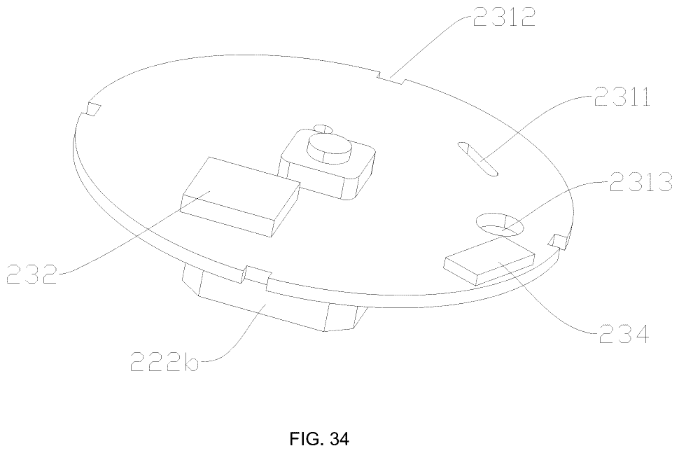

Referring to FIGS. 29-34, an embodiment of the present disclosure relates to another specific structure/configuration of a positioning device, which may be a bolt or bolt-like assembly 20. The bolt 20 may include a head portion 210 and a shank portion 220, with a positioning apparatus 130a disposed within the head portion 210 of the bolt 20. The shank portion/base part 220 is provided with a mounting portion, which may be threaded to connect to other components via threads. In other examples, the mounting portion may be a magnetic attachment component. In other examples, the mounting portion may be a snap-fit component. In other examples, at least a portion of the mounting portion may be made of adhesive materials such as glue. In this embodiment, by mounting the positioning apparatus 130a within the head portion 210 of the bolt 20, the concealment of the positioning apparatus 130a is enhanced, preventing it from being discovered and removed, ensuring that the user can track and monitor the position of the bolt 20 in real time, thereby providing a good anti-theft effect. Additionally, the carrier may be any commercially available vehicle. Since nearly all vehicles require bolts 20 to secure their components, in this embodiment, by disposing the positioning apparatus 130a within the head portion 210 of the bolt 20, the positioning apparatus 130a can be applied to any scenario requiring the use of a bolt 20, greatly expanding the application range of the positioning apparatus 130a with improved concealment. Users can conveniently locate their vehicles, such as bicycles, with the aid of the bolt 20.

In this embodiment, the shape of the head portion 210 is not particularly limited; preferably, it may be substantially cylindrical. In other examples, the head portion 210 may be cubic. Additionally, the manufacturing material of the head portion 210 is not particularly limited; for example, the head portion 210 may be made of metal, plastic, glass, wood, composite materials, fiber-reinforced materials, or a combination thereof. Preferably, for instance, the head portion 210 may be made of ABS plastic or nylon plastic.

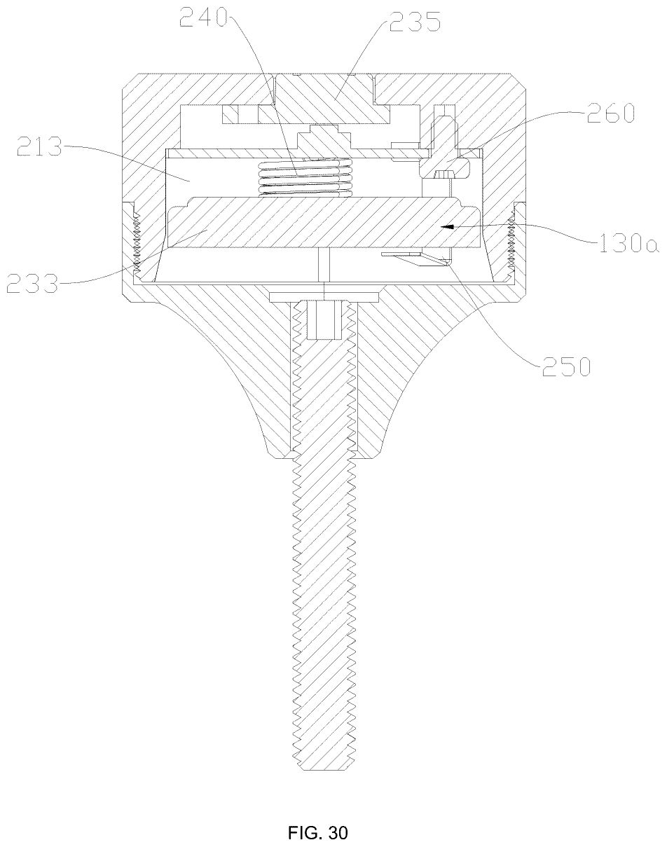

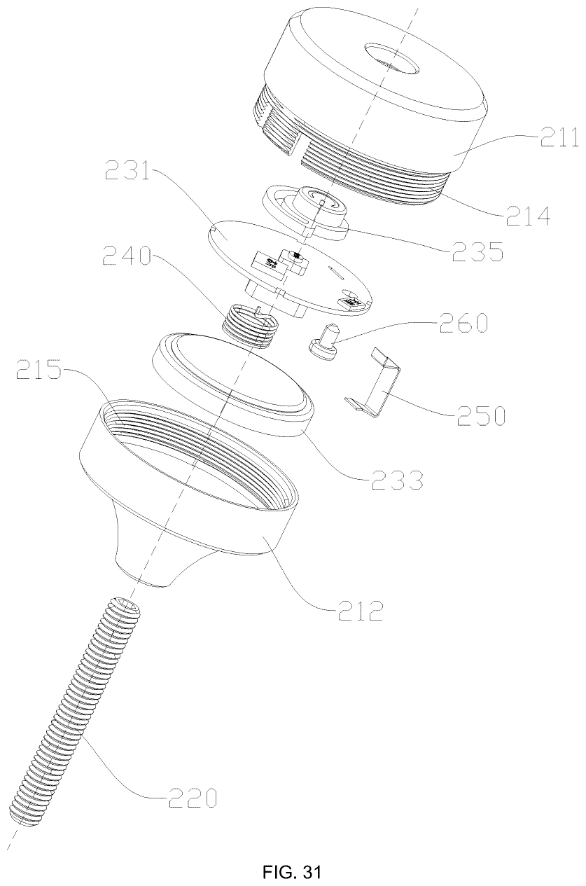

Specifically, referring to FIGS. 30 and 31, the head portion 210 includes a first cap body 211 and a second cap body 212, which together enclose a mounting cavity 213, with the positioning apparatus 130a fixed within the mounting cavity 213. For example, one end of the first cap body 211 and one end of the second cap body 212 are both open, with a first threaded portion 214 provided at the open end of the first cap body 211 and a second threaded portion 215 provided at the open end of the second cap body 212. By mating the first threaded portion 214 with the second threaded portion 215, the first cap body 211 and the second cap body 212 can be fixedly connected, providing a stable structure after threaded connection that is not easily detached. When the positioning apparatus 130a is damaged or runs out of power, simply unscrewing the first cap body 211 allows for repair or replacement of the positioning apparatus 130a. In some examples, the positioning apparatus can be entirely replaced by an AirTag locator manufactured by Apple Inc.

In some embodiments, the first cap body 211 and the second cap body 212 may also be fixed by a snap-fit connection. For example, a snap is provided at the open end of the first cap body 211, and a slot is provided at the open end of the second cap body 212, allowing the first cap body 211 and the second cap body 212 to be fixedly connected by mating the snap with the slot.

In some embodiments, the first cap body 211 and the second cap body 212 may also be fixed by magnetic attachment. For example, a first attachment member is provided on the first cap body 211, and a second attachment member is provided on the second cap body 212, allowing the first cap body 211 and the second cap body 212 to be fixedly connected by mating the first attachment member with the second attachment member. One of the first and second attachment members is a magnet, while the other is a magnet or a metal.

Optionally, in some embodiments, referring to FIGS. 30-34, the positioning apparatus may include a circuit board 231, an antenna module 234, a chip 232, a buzzer 222b, and a battery 233, or a suitable combination of these electronic components/devices. The antenna module 234, the chip 232, and the buzzer 222b are all connected to the circuit board 231. The antenna module 234 is configured to periodically receive and transmit wireless signals within its communication range, such as GPS signals or cellular network signals. The chip 232 typically includes a processor configured to receive and decode wireless signals from the antenna module 234, run positioning algorithms, and process related data, while also controlling the buzzer 222b to emit an audio output, such as a beep or other audible tone (e.g., a constant tone, a song, etc.).

The battery 233 is configured to power the system and is connected to the circuit board 231 via a first conductive member 240 and a second conductive member 250. One end of the first conductive member 240 is connected to the circuit board 231, and the other end is connected to the positive pole of the battery 233, which may be the side of the battery 233 facing the circuit board 231. One end of the second conductive member 250 is connected to the circuit board 231, and the other end is connected to the negative pole of the battery 233, which may be the side of the battery 233 facing away from the circuit board 231, thereby forming a closed circuit with the positioning apparatus.

For example, the first conductive member 240 is a spring, enabling an elastic connection between the battery 233 and the circuit board 231, ensuring good physical contact between the battery 233 and the circuit board 231, maintaining a stable connection even with slight movement of the battery 233 or the circuit board 231. The second conductive member 250 may be a metal strip, substantially U-shaped, with a slot 2311 provided on the circuit board 231. One end of the metal strip is inserted into the slot 2311, and the other end is connected to the side of the battery 233 facing away from the circuit board 231. Since the second conductive member 250 is made of metal, it has good electrical conductivity, effectively transmitting current, and the U-shaped metal strip can retain the battery 233, ensuring a stable connection between the battery 233 and the circuit board 231. A switch assembly 235 is also provided on the circuit board 231, including a push-type switch that powers the system when pressed and cuts power when pressed again.

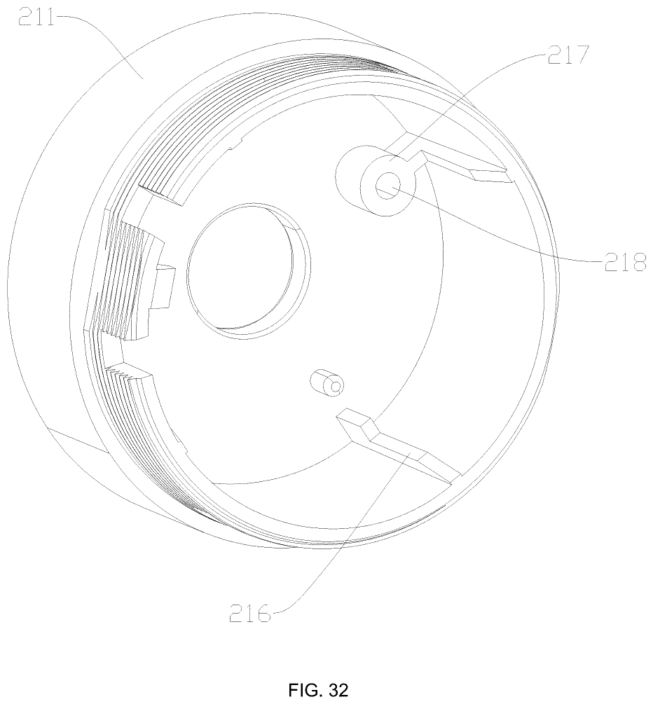

Optionally, in some embodiments, referring to FIGS. 32-34, the inner peripheral wall of the first cap body 211 is provided with multiple retaining members 216, and the circuit board 231 is provided with multiple retaining notches 2312, with the multiple retaining notches 2312 corresponding one-to-one with the multiple retaining members 216, preventing radial displacement of the circuit board 231 within the mounting cavity 213. Specifically, the retaining members 216 may be retaining protrusions distributed in a circumferential array on the inner peripheral wall of the first cap body 211. When installing the circuit board 231, each retaining protrusion mates with a corresponding retaining notch 2312, thereby restricting radial movement of the circuit board 231.

Further, referring to FIGS. 31, 32, and 34, the circuit board 231 is provided with a first mounting hole 2313, and the inner wall of the first cap body 211 is provided with a boss 217 having a second mounting hole 218. A fastener 260 sequentially passes through the first mounting hole 2313 and the second mounting hole 218 to fix the circuit board 231 within the first cap body 211, preventing axial displacement of the circuit board 231 within the mounting cavity 213. For example, the second mounting hole 218 may be a threaded hole, and the fastener 260 may be a screw, fixing the circuit board 231 to the first cap body 211 via a screw connection, effectively preventing loosening of the circuit board 231.

The embodiments and technical features described above in the present disclosure can be reasonably combined without apparent conflict, and the technical solutions and/or technical principles of one embodiment can be used to explain related technical solutions and/or technical principles of another embodiment. For brevity, not all possible combinations of the technical features in the above embodiments have been described; however, as long as there is no contradiction in the combination of these technical features, they should be considered within the scope of this specification.

The foregoing provides an overview of certain aspects of the invention to familiarize the reader with some aspects thereof. This overview is neither a comprehensive summary nor an exhaustive description of the invention. It is not intended to identify key or critical features of the invention or to delineate the scope of protection of the invention, but rather to present certain concepts of the invention in a simplified form. Those skilled in the art will understand that other aspects, embodiments, and configurations of the invention may use one or more of the features described above, either individually or in combination. Those skilled in the art will further understand that other embodiments of the invention may use one or more of the features described above, either individually or in combination. For example, the inventors believe that various features and devices related to one embodiment may be combined with or substituted for features or devices of other embodiments, whether such combinations or substitutions are specifically shown or described in the invention. Other aspects of the invention, particularly when viewed in conjunction with the drawings, will become more apparent from the detailed description.

1. A positioning device comprising:
a head portion including a first cap body and a second cap body, wherein the first cap body and the second cap body enclose a mounting cavity;
a shank portion connected to the head portion, the shank portion including a mounting portion configured to secure the positioning device to an external carrier; and
a positioning apparatus mounted within the mounting cavity and configured to communicatively connect with an external electronic device to enable the external electronic device to locate the external carrier.

2. The positioning device of claim 1, wherein the positioning apparatus comprises a circuit board, a battery, a first conductive member, and a second conductive member, wherein the battery is connected to the circuit board via the first conductive member and the second conductive member.

3. The positioning device of claim 2, wherein the first conductive member is a spring; and/or the second conductive member is a metal strip.

4. The positioning device of claim 2, wherein the circuit board includes a slot, the second conductive member is U-shaped, one end of the second conductive member is inserted into the slot, and the other end of the second conductive member abuts a side of the battery facing away from the circuit board.

5. The positioning device of claim 2, wherein an inner peripheral wall of the first cap body is provided with a plurality of retaining members spaced apart, the circuit board is provided with a plurality of retaining notches, and the plurality of retaining members are respectively mounted in correspondence with the plurality of retaining notches.

6. The positioning device of claim 2, further comprising a fastener, wherein the circuit board includes a first mounting hole, the first cap body includes a boss therein, the boss includes a second mounting hole, and the fastener sequentially passes through the first mounting hole and the second mounting hole to fixedly connect the circuit board to the first cap body.

7. The positioning device of claim 1, wherein the mounting portion of the shank portion comprises a threaded structure configured to secure the positioning device to the carrier by threaded engagement.

8. The positioning device of claim 1, wherein the carrier is a transportation vehicle selected from the group consisting of a bicycle, an electric bicycle, a scooter, and a self-balancing vehicle.

9. A positioning device comprising:
a head portion including a detachable first part and a second part, wherein the first part and the second part define at least a part of a mounting cavity;
a mounting base located below the head portion and configured to secure the positioning device to an external carrier;
a positioning apparatus mounted within the mounting cavity and configured to locate the external carrier;
a battery configured to power the positioning device;
a control circuit; and
an audio device;
wherein the positioning apparatus is configured to periodically transmit a first wireless signal receivable by a first electronic device;
wherein the first electronic device locates the external carrier based on the first wireless signal; and
wherein the positioning apparatus is further configured to receive a second wireless signal transmitted by a second electronic device, the control circuit controlling the audio device to generate a sound based on the second wireless signal to facilitate location of the positioning device.
